(19) United States
(12) Patent Application Publication
(10) Pub. No.: US 2017/0322521 A1
(43) Pub. Date: Nov. 9, 2017

(54) REDUNDANT ETHERNET-BASED CONTROL APPARATUS AND METHOD

(71) Applicant: General Electric Company, Schenectady, NY (US)

(72) Inventors: John Alexander PETZEN, Salem, VA (US); Fred Henry BOETTNER, Salem, VA (US)

(21) Appl. No.: 15/532,760

(22) PCT Filed: Dec. 9, 2014
(86) PCT No.: PCT/US2014/069177

§ 371 Date: Jun. 2, 2017

(51) Int. Cl. G05B 9/03

(52) U.S. Cl. CPC G05B 9/03

(57) ABSTRACT

Approaches for redundant control for at least one active controller configured to perform a plurality of functions and communicate with a plurality of components over a communications network in a multi-controller system is provided. The redundant controller is configured to perform a plurality of functions which are identical to the plurality of functions being performed at the active controller and determine whether a failure of the active controller has occurred. Upon determining that a failure of the active controller has occurred, the redundant controller assumes assuming the role of the active controller such that it performs the functions that are identical to the functions being performed at the active controller and communicates with the components over the communications network.

### FIELD OF THE INVENTION

The subject matter disclosed herein generally relates to standby controllers for a redundant control system.

### BRIEF DESCRIPTION OF THE RELATED ART

A variety of approaches have been used in the application of redundant hardware when applied in redundant control contexts. Because control systems oftentimes pertain to critical hardware and software functionality, it is important to have backup systems in place in the event of hardware failure. Oftentimes, a number of controllers are employed which each communicate to devices in the system. Because these system devices may be critical in nature, it is important that associated controllers experience little to no downtime.

In the event of controller failure, the controller must be replaced to restore proper system functionality. While some existing redundant systems are reliable in service, these systems do not allow for the retention of full redundancy if a controller fails. In other words, existing redundant controller based systems may require a disruptive repair to replace a failed controller.

Existing systems also frequently require the controller to be in the same physical location as the failed controller and must be swapped with the failed controller. This process is oftentimes time consuming and may lead to substantial system downtime. For example, a system operator may not be in the same location as the failed control device and thus the process may take a substantial amount of time to fully restore the system. Further, because these controllers are oftentimes stored in close proximity to one another, if localized casualty were to occur such as a cabinet fire or flood, both the active and redundant controllers may be compromised.

Further still, upon replacing the controller with a functioning unit, operators must program the controller in order to assign necessary functionality thereto. This in turn may lead to additional downtime. In the present technological environment, systems maximize efficiencies by reducing any system downtime and maintain system functionality, thus any time expended on repairs may result in substantial financial losses.

The above-mentioned problems have resulted in some user dissatisfaction with previous approaches.

### BRIEF DESCRIPTION OF THE INVENTION

The approaches described herein provide control systems with a way to seamlessly replace a failed controller with a redundant controller that performs the same functions as the failed controller. The redundant controller is in communication with the networks, allowing the redundant controller to perform the same tasks as the active controller while not transmitting information to the desired system. Upon experiencing a controller failure, the redundant controller may then assume the role of the failed controller and communicate over the appropriate network as if it were the failed controller.

Advantageously, due to the redundant controller's ability to quickly or instantaneously assume the identity of the failed controller, full system redundancy and functionality may be maintained after the controller fails. The failed controller may then be replaced with no process disruption. Higher system and process availability are thereby possible due to additional controller redundancies. Furthermore, even if the system or process is in a fully operational state, the redundant controller may be upgraded to a new control software version while the process is still running.

Additionally, the control systems may be physically distributed in different areas which may in turn lead to greater protection against physical threats. Because controller replacement requires no system shut down, higher profits may be realized due to the continued system operation.

In some approaches, a redundant control system is provided having an input system configured to receive data at an input, a plurality of networks coupled to the input system, a number of active controllers, a processing device, and a redundant controller. The active controllers each have an input coupled to each of the plurality of networks and an output coupled to each of the plurality of networks. As such, transmissions from the output of the active controller are transmitted across a single network. The processing device is configured to receive the outputs from the plurality of active controllers. The redundant controller also has an input coupled to each of the plurality of networks and an output coupled to the processing device. The redundant controller is configured to detect a failure of any of the active controllers and, upon doing so, the redundant controller is configured to assume the identity of the failed controller and transmit an identical output of the failed controller across the single network coupled to the processing device.

In some of these approaches, the redundant controller is further configured to transmit the identical output directly to the processing device. The redundant controller may also be configured to instruct the remaining active controllers that the redundant controller has assumed the role of the failed controller.

In some approaches, upon assuming the role of the failed controller, the redundant controller may be configured to preclude the failed controller from transmitting an output across the single network. As such, in the event the failed controller resumes normal operation, multiple controls will not be sent to the processing device via the network.

It is understood that in some examples, a plurality of redundant controllers may be employed which may assume the role of any number of failed active controllers. The redundant controller or controllers may be disposed at a remote location from the active controllers to provide for an additional layer of security from potentially damaging events and/or incidents.

Further, in some examples, a number of active controller networks may be provided which each communicate through the plurality of networks. For example, a safety controller and a primary controller may co-exist on one network while remaining independent. In the event of a failure of either one of the safety controller and the primary controller, the redundant controller may assume the identity of the failed controller and communicate with the network to the extent previously utilized by the controller while maintaining independence from the other active controller.

In still other approaches, a controller for providing redundant control of an active that performs a number of functions and communicate with a number of components over a communications network in a multi-controller system is provided. The controller includes an interface having an input and an output and a processor coupled thereto.

The processor is configured to perform a plurality of identical functions as those performed by the active controller. Further, the processor is configured to determine whether a failure of the active controller has occurred by listening for activity of the active controller at the input. Upon determining that a failure of the active controller has occurred, the controller is then configured to assume the role of the active controller such that the controller performs the plurality of identical functions and communicates with the plurality of components via the output over the communications network.

In certain aspects, the processor is further configured to transmit a signal via the output of the interface to notify the remaining controllers that the controller has assumed the role of the active controller. In many of these aspects, the processor is further configured to transmit a signal via the output of the interface that precludes the active controller from performing the plurality of functions and from communicating with the plurality of components over the communications network.

In some approaches, the processor is further configured to perform a plurality of identical functions received at the input of the interface as the functions performed by a plurality of active controllers configured to communicate over a plurality of corresponding communication networks. The processor may further be configured to assume the role of any of the active controllers such that the controller performs the plurality of identical functions and communicates with the plurality of components over the corresponding communication network.

In other aspects, an approach for redundant control for at least one active controller configured to perform a plurality of functions and communicate with a plurality of components over a communications network in a multi-controller system is provided. At a redundant controller, a plurality of functions are performed that are identical to the plurality of functions being performed at the active controller. The redundant controller determines whether a failure of the active controller has occurred, and upon determining a failure has occurred, the redundant controller assumes the role of the active controller such that it performs the plurality of functions that are identical to the functions being performed at the active controller and communicates with the components over the communications network.

The redundant controller may also notify the remaining controllers that it has assumed the role of the active controller. The redundant controller may also preclude the failed controller from performing the functions and from communicating with the components over the communications network.

So configured, the approaches described herein may be used to provide a near-instant backup for a failed controller. Because the redundant controller performs all of the functions of the active controllers prior to the active controller experiencing failure, the redundant controller may quickly assume the role of the failed controller thus resulting in minimal system downtime. The approaches may be Ethernet-based, thus the redundant controller may be located remotely from the active controllers. As a result, if a damaging event caused the failure of the controller, the redundant controller may be safe from harm.

### BRIEF DESCRIPTION OF THE DRAWINGS

For a more complete understanding of the disclosure, reference should be made to the following detailed description and accompanying drawings wherein:

FIG. 1 comprises a block diagram illustrating an exemplary redundant control system (e.g., Ethernet-based) according to various embodiments of the present invention;

FIG. 2 comprises a system diagram illustrating an exemplary redundant control system (e.g., Ethernet-based) according to various embodiments of the present invention; and

FIG. 3 comprises a flow chart illustrating an approach for a redundant control system control according to various embodiments of the present invention.

Skilled artisans will appreciate that elements in the figures are illustrated for simplicity and clarity. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION OF THE INVENTION

Approaches are provided that allow for on the fly system redundancy of control systems by providing a redundant controller which performs the same functions of any number of desired active controllers. However, this redundant controller does not transmit any information until it senses that a controller has failed. Accordingly, the controller may be “activated” upon detecting a failure, at which time the redundant controller seamlessly performs the identical functions as the failed controller.

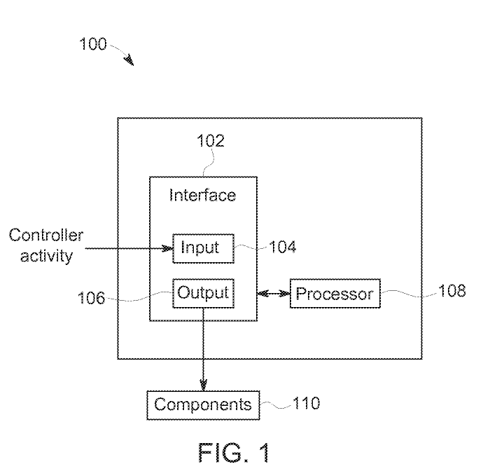

Referring now to FIG. 1, one example of a redundant control system 100 (e.g., Ethernet-based) is described. The redundant control system 100 includes an interface 102 having an input 104 and an output 106, a controller or processor 108, and a processing device 110. The interface 102 is a computer-based program and/or hardware configured to accept controller activity or a signal or communication from a computing device such as a personal computer, a mobile computing device, a control system or server at the input 104 and transmit the generated communication at the output 106 to the processing device 110, which may also be a computing system. The function of the interface 102 is to allow the processor 108 to communicate with the controller(s) and the processing device 110. It is understood that in some examples, the controllers coupled to the input 104 may be separate devices in communication with the interface 102.

The processor 108 is any combination of hardware devices and/or software selectively chosen to process controller activity related to a control system and perform appropriate functions to be sent to the processing device 110 via the output 106. The processor 108 includes instructions that determine when the active controllers have failed

It will be appreciated that the various components described herein may be implemented using a general purpose processing device executing computer instructions stored in memory. Further, it is understood that the processor 108 may be a standalone component or may be incorporated into the interface 102.

The processing device 110 may include any number of components which receive instructions or commands from the system 100. The processing device 110 may in turn process any transmissions from the system 100 to maintain operation of the control system.

In operation, upon receiving activity from a controller at the input 104, the processor 108 performs identical functions as those performed by the active controller. The processor then determines whether a failure of the active controller has occurred by listening for controller activity at the input 104. In one example, this determination may occur due to a period of inactivity of the active controller when the processor is expecting to receive activity from the controller at the input. The processor 108 may be programmed to contain timing data relating to activity of the control system to assist in making the failure determination. It is understood that other examples are possible.

Upon the processor 108 determining that a failure of the active controller has occurred, the processor is then configured to assume the role of the active controller such that the apparatus performs the plurality of identical functions as the previously active controllers and communicates with the processing device 110 via the output 106 over the communications network.

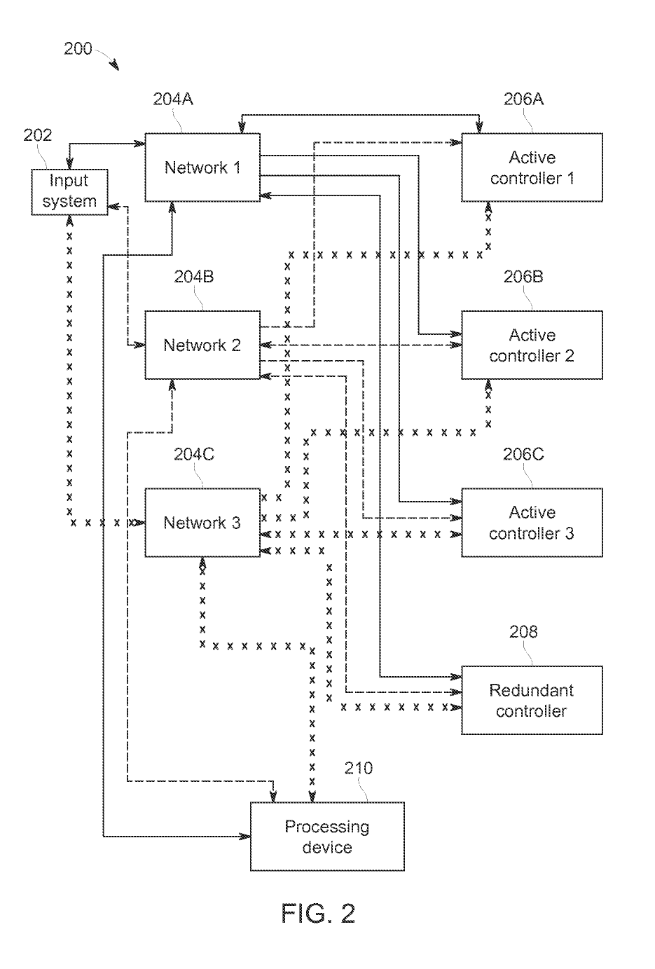

Turning now to FIG. 2, further detail of the redundant control system 200 (e.g., Ethernet-based) is provided. The system 200 may include an input system 202, any number of networks 204A, 204B, 204C, any number of active controllers 206A, 206B, 206C, a redundant controller 208, and a processing device 210.

The input system 202 is configured to receive data at an input. This data may originate from any number of sensors, components, machinery, or other apparatuses used in a control system environment. The input system may then transmit this data to the networks 204A, 204B, 204C. It is understood that in some examples, greater or fewer networks may be utilized.

In the system 200, the input system 202 communicates with each network using a unique communication path. By “communication path” and as used herein, it is meant a component or group of components through which a message may be sent from one component to another component. The communication paths between components may be Ethernet-based, and may be wired or wireless in nature. Other examples are possible.

It will be appreciated that the redundant controller 208 (or any of the redundant controllers described herein) is not limited to a single redundant controller. More specifically, multiple redundant controllers could be geographically distributed, and may be capable of acting as replacements for more than one failed controller. To take one example: a first basic process controller fails and the first backup takes its place. A second basic process controller fails (with the first backup now regarded as one of the basic process controllers) and a second backup controller takes its place. This approach could be extended to any desired number of backup controllers.

As illustrated in FIG. 2, communication from the input system 202 to the first network 204A is in a first format denoted by solid lines, communications from the input system 202 to the second network 204B is in a second communication path denoted by broken lines, and communications from the input system 202 to the third network 204C is in a third communication path denoted by x's. Each of these communication paths include unique information which is used by the particular controller to perform desired functions.

Each network 204A, 204B, 204C sends communications to each of the active controllers 206A, 206B, 206C and the redundant controller 208 using all three communication paths. Thus, the first active controller 206A is configured to receive communications from all three networks 204A, 204B, 204C. However, each controller is configured to provide an output using a single communication path, and thus may only transmit its output to a single network. As an example, the first controller 206A is configured to transmit its output to the first network 204A, the second controller 206B to the second network 204B, and the third controller 206C to the third network 204C. The information received by the networks 204A, 204B, 204C at the active controllers 206A, 206B, 206C is used by the active controllers 206A, 206B, 206C to perform functions and calculations required for normal operation of the control system. Additionally, the redundant controller 208 receives these same transmissions from networks 204A, 204B, 204C and performs identical calculations and functions as the active controllers 206A, 206B, 206C, but does not transmit information back to the networks.

The networks 204A, 204B, 204C also transmit information from the output of the active controllers 206A, 206B, 206C to the processing device 210 using the designated communications path. This information is used by the control system in accordance with the design thereof.

In operation, the redundant controller 208 may determine or sense whether the controller 206A, 206B, 206C is actively transmitting information or data to the designated network 204A, 204B, 204C using any number of methods such as by comparing the frequency of transmissions received at the networks 204A, 204B, 204C to expected transmission frequencies. If the redundant controller 208 determines that a failure has occurred at one of the controllers 206A, 206B, 206C, it will assume the role of the failed controller.

To accomplish this, the redundant controller 208 is not only configured to receive transmissions from each network 204A, 204B, 204C across each of the unique communications paths, it is also configured to transmit output communications in which completed calculations or functions have been performed to each of the networks 204A, 204B, 204C using the appropriate unique communication path. For example, the redundant controller 208 may transmit communications to the first network 204A using the first communication path (denoted by solid lines), to the second network 204B using the second communication path (denoted by broken lines), and to the third network 204C using the third communication path (denoted by x's). When the designated network receives this transmission, the transmission is sent to the processing device 210.

So configured, the redundant controller 208 may assume the role of the failed controller by transmitting the identical transmission to the appropriate network 204A, 204B, 204C using the appropriate communication path. The network then transmits this information to the processing device 210 in the same manner as it would with information derived from active controller 206A, 206B, 206C.

In some approaches, the redundant controller 208 is configured to instruct the remaining active controllers 206A, 206B, 206C that it has assumed the role of the failed controller. This may occur via a communication being sent to the network designated for the failed controller, which may in turn transmit this information to the active controllers. The redundant controller 208 may also be configured to preclude the failed controller from transmitting an output thereto using the communication path. For example, the redundant controller 208 may transmit a communication to the network 204A, 204B, 204C instructing it to only accept communications from a particular component identifier associated with the redundant controller 208. As such, in the event that the previously failed controller regains operation, the network 204A, 204B, 204C will not receive two transmissions from controllers.

It is understood that while a single redundant controller 208 is illustrated in FIG. 2, any number of redundant controllers may be used. These additional redundant controllers may also communicate with each of the networks using their designated communication path. Thus, an even more robust system may be used in which multiple failed controllers may be accounted for in little time.

Additionally, any number of active controller systems may be provided which each may communicate through the plurality of networks. For example, a safety control system which is used for safety features of a control system and a primary or basic processing system used to keep the process operational may co-exist on any number of unique networks while remaining independent from each other. As an example, a safety controller and a primary controller may both communicate with a single network using a single communication path, but may function independent of each other. Similarly, additional safety controllers and primary controllers may communicate with other networks using communication paths that are unique from the first communication paths. It is understood that by “safety controller,” it is meant a system which is used to significantly lower the risk in a process control or system beyond any safety features found in the primary controller.

In these examples, in the event of a failure of either one of the safety controller and the primary controller, the redundant controller may assume the identity of the failed controller and communicate with the network to the extent previously utilized by the controller while maintaining independence from the other active controller. Thus, the redundant controller or controllers may be used in conjunction with multiple systems which partially share communications networks.

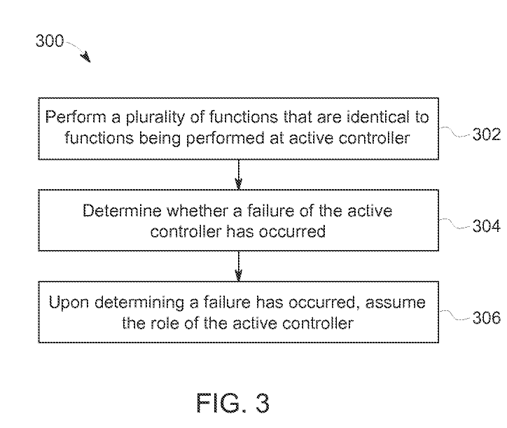

Turning to FIG. 3, an approach for redundant control (e.g., Ethernet, based) of an active controller is provided. The active controller is configured to perform a number of functions and communicate with a number of components over a communications network in a multi-controller system. At a redundant controller, at step 302, a plurality of functions which are identical to functions being performed at an active controller are performed. Next, at step 304, a determination is made as to whether a failure of the active controller has occurred. Finally, at step 306, upon determining that a failure has occurred, the redundant controller assumes the role of the active controller such that the redundant controller performs the functions which are identical to the functions being performed at the active controller. The redundant controller then may communicate with the components over the communications network.

In these approaches, the redundant controller may also notify the remaining controllers that it has assumed the role of the active controller. The redundant controller may also preclude the failed controller from performing the functions and from communicating with the components over the communications network.

It will be appreciated by those skilled in the art that modifications to the foregoing embodiments may be made in various aspects. Other variations clearly would also work, and are within the scope and spirit of the invention. The present invention is set forth with particularity in the appended claims. It is deemed that the spirit and scope of that invention encompasses such modifications and alterations to the embodiments herein as would be apparent to one of ordinary skill in the art and familiar with the teachings of the present application.

What is claimed is:

1. A method of redundant control for at least one active controller, the at least one active controller being configured to perform a plurality of functions and communicate with a plurality of components over a communications network in a multi-controller system, the method comprising:
at a redundant controller:
performing a plurality of functions that are identical to the plurality of functions being performed at the at least one active controller;
determining whether a failure of the at least one active controller has occurred;
upon determining that a failure of the at least one active controller has occurred resulting in a failed controller, assuming a role of the failed controller such that the redundant controller performs the plurality of functions that are identical to the plurality of functions being performed at the at least one active controller and communicates with the plurality of components over the communications network.

2. The method of redundant control of claim 1, further comprising the step of the redundant controller notifying at least one remaining controller that the redundant controller has assumed the role of the failed controller.

3. The method of redundant control of claim 1, further comprising the step of the redundant controller precluding the failed controller from performing the plurality of functions and from communicating with the plurality of components over the communications network.

4. The method of redundant control of claim 1, further comprising a plurality of active controllers.

5. A controller for providing redundant control of an active controller configured to perform a plurality of functions and communicate with a plurality of components over a communications network in a multi-controller system, the controller comprising:
an interface having an input and an output;
a processor coupled to the interface, the processor configured to perform a plurality of identical functions as the functions performed by the active controller, the processor further configured to determine whether a failure of the active controller has occurred by listening for activity of the active controller at the input;
wherein upon determining that a failure of the active controller has occurred, the controller is configured to assume a role of the active controller such that the controller performs the plurality of identical functions and communicate with the plurality of components via the output over the communications network.

6. The controller of claim 5, wherein the processor is further configured to transmit a signal via the output of the interface to notify at least one remaining controller that the controller has assumed the role of the active controller.

7. The controller of claim 5, wherein the processor is further configured to transmit a signal via the output of the interface, the signal being effective to preclude the active controller from performing the plurality of functions and from communicating with the plurality of components over the communications network.

8. The controller of claim 5, wherein the processor is further configured to perform a plurality of identical functions received at the input of the interface as the functions performed by a plurality of active controllers configured to communicate over a plurality of corresponding communication networks, the processor further configured to assume the role of any of the active controllers such that the controller performs the plurality of identical functions and communicates with the plurality of components over the corresponding communication network.

9. A redundant control system comprising:
an input system configured to receive data at an input;
a plurality of networks coupled to the input system;
a plurality of active controllers, each of the plurality of active controllers having an input coupled to each of the plurality of networks and an output coupled to one of the plurality of networks such that transmissions from the output of the active controller are transmitted on a single network;
a processing device configured to receive the output from the plurality of active controllers; and
a redundant controller, wherein the redundant controller comprises an input coupled to each of the plurality of networks and an output coupled to the plurality of networks, wherein the redundant controller is configured to detect a failure of any of the plurality of active controllers and upon detecting a failed controller, the redundant controller is configured to assume an identity of the failed controller and transmit an identical output of the failed controller across the single network coupled to the processing device.

10. The redundant control system of claim 9, wherein the redundant controller is further configured to transmit the identical output to the processing device.

11. The redundant control system of claim 9, wherein the redundant controller is configured to instruct the at least one remaining controller that the redundant controller has assumed the identity of the failed controller.

12. The redundant control system of claim 11, wherein the redundant controller is configured to preclude the failed controller from transmitting an output across the single network.

13. The redundant control system of claim 9 further comprising a plurality of redundant controllers.

14. The redundant control system of claim 9, wherein the redundant control system is disposed at a remote location from the plurality of active controllers.

15. A system, the system comprising:
a first set of controllers;
a second set of controllers;
a single set of networks, the first set of controllers sharing operational usage of the single set of networks with the second set of controllers;
a first redundant controller coupled to the single set of networks, wherein the first redundant controller is configured to detect a failure of any controller within either the first set of controllers or the second set of controllers, and upon detecting a failed first controller, the first redundant controller is configured to assume an identity of the failed first controller and transmit an identical output of the failed first controller across the single set of networks.

16. The system of claim 15, further comprising a second redundant controller, coupled to the single set of networks, wherein the second redundant controller is configured to detect a failure of any controller including the first redundant controller within either the first set of controllers or the second set of controllers, and upon detecting a failed second controller, the second redundant controller is configured to assume the identity of the failed second controller and transmit an identical output of the failed second controller across the single set of networks.

17. The system of claim 15, wherein the first redundant controller is further configured to transmit the identical output to a processing device.

18. The system of claim 15, wherein the redundant controller is configured to instruct at least one remaining controllers from at least one of the first set of controllers and the second set of controllers that the redundant controller has assumed the identity of the failed first controller.

19. The system of claim 15, wherein the redundant controller is configured to preclude the failed first controller from transmitting an output across the single set of networks.
